(19) United States
(12) Patent Application Publication
(10) Pub. No.: US 2007/0022179 A1
(43) Pub. Date: Jan. 25, 2007

(54) Display device with cable card and updating method thereof

(75) Inventors: Dong-Won Kim, Suwon-si (KR); Byoung-Gun Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/482,879

(22) Filed: Jul. 10, 2006

(30) Foreign Application Priority Data
Jul. 22, 2005 (KR) 2005-0066618

(51) Int. Cl. G06F 15/16

(52) U.S. Cl. 709/217

(57) ABSTRACT

A display device having a cable card is provided wherein the cable card stores firmware, an interface that receives homing information from a service provider, an update part that updates the cable card firmware according to the homing information, a storage part that stores node information about at least one corresponding node, a message generator that generates a message indicating an update of the firmware of the cable card, and a communication part that transmits the message to the at least one corresponding node. The corresponding node information may be a phone number and the communication part can access a short messenger service center to transmit an SMS text message to the corresponding node. Accordingly, a user can be easily aware of the firmware update.

### PRIORITY

This application claims the benefit under 35 U.S.C. § 119(a) of Korean Patent Application No. 2005-66618, filed Jul. 22, 2005 in the Korean Intellectual Property Office, the entire content of which is hereby incorporated by reference.

### BACKGROUND OF THE INVENTION

1. Field of the Invention:

The present invention relates to a display device with a cable card and an updating method thereof More particularly, the present invention relates to a display device with a cable card capable of receiving homing information from a service provider and updating cable card firmware, and to an updating method thereof.

2. Description of the Related Art:

Traditional display devices receive various types of services from service providers such as ground wave broadcast stations, cable companies, digital satellite systems, and Internet service providers. The service providers generally provide scrambled broadcasting programs.

In order to unscramble broadcast programs, a cable card must be inserted in the display device in order for a viewer to normally watch broadcast signals transmitted from a cable company. The cable card is mountable to the display device and is typically a smart card that stores subscriber information and a descrambling key value. The display device has to descramble a cable broadcast signal using the descrambling key value stored in the cable card. Prior to descrambling, the display device implements user authentication using the subscriber information stored in the cable card.

Cable companies periodically update cable card firmware depending on whether a subscriber has paid for a broadcasting program provided by the cable company.

The operation of updating cable card firmware is called “homing.” A signal transmitted from a broadcast station to update the firmware is called a “homing signal.” The homing signal includes a message about the firmware update, cable card firmware update data, and a time that is required to update the firmware.

When homing is performed, a conventional display device displays a message on screen about the firmware update such that a viewer is aware of the update. However, if homing is performed while the display device is turned off, a viewer is unaware of the firmware update.

Also, although homing is performed when the display device is turned on, a user who is physically remote from the display device or is engaged with other work is unaware of the message displayed on screen. Thus, there is a demand for a display device that can more definitively inform a user of cable card firmware updates.

### SUMMARY OF THE INVENTION

The present invention has been developed to address the above and other problems in the related art. Accordingly, an aspect of the present invention provides a display device which transits a message about an update to cable card firmware to a pre-set corresponding node such that a user is aware of the firmware update, and an updating method thereof.

The above exemplary aspect of the present invention is achieved by providing a display device comprising a cable card that stores firmware, an interface that receives homing information from a service provider, an update part that updates the firmware of the cable card according to the homing information, a storage part that stores corresponding node information about at least one corresponding node, and a message generator that generates a message indicating an update of the cable card firmware, and a communication part that transmits the message to the at least one corresponding node.

In an exemplary embodiment of the present invention, the corresponding node information comprises a telephone number.

In an exemplary embodiment of the present invention, the communication part accesses a short message service center (SMSC) and provides the SMSC with the telephone number and message such that the SMSC transmits the message to a node corresponding to the telephone number in the form of an SMS text message.

In an exemplary embodiment of the present invention, the display device further comprises an on screen display (OSD) processor that provides an OSD to receive the telephone number and store the telephone number to the storage part.

The above aspect is also achieved by providing a method for updating a cable card of a display device which stores firmware in the cable card. The method comprises receiving homing information from a service provider, updating the cable card firmware according to the homing information, generating a message indicating an update of the firmware, and transmitting the message to a pre-set corresponding node.

In another exemplary embodiment, a message transmission operation comprises reading a telephone number from memory, accessing a short message service center (SMSC), and providing the SMSC with the telephone number and message such that the SMSC transmits an SMS text message to a node corresponding to the telephone number.

### BRIEF DESCRIPTION OF THE DRAWINGS

The above and other aspects and features of the present invention will become more apparent by describing certain exemplary embodiments of the present invention with reference to the accompanying drawings, in which:

FIG. 1 is a block diagram illustrating a display device according to an exemplary embodiment of the present invention;

FIG. 2 is a view illustrating an environment where the exemplary embodiment of the display device of FIG. 1 operates; and

FIG. 3 is a flowchart illustrating a method for updating a cable card according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

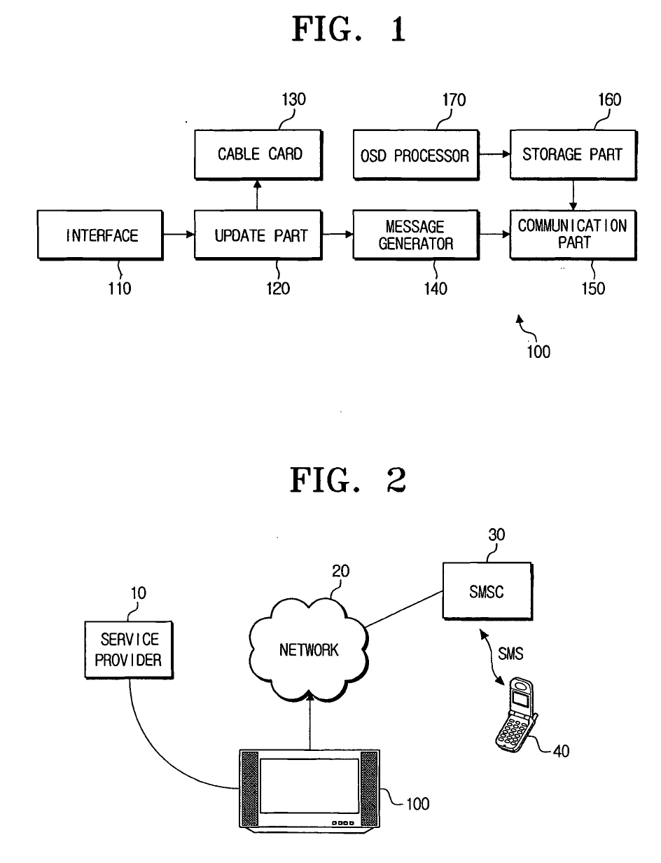

FIG. 1 is a block diagram illustrating a display device 100 according to an exemplary embodiment of the present invention. The display device 100 comprises an interface 110, an update part 120, a cable card 130, a message generator 140, a communication part 150, a storage part 160, and an OSD processor 170.

The cable card 130 stores firmware where subscriber information and a descrambling key value are recorded.

The interface 110 receives a homing signal from a service provider, such as a cable company. The homing signal updates the firmware of the cable card 130. The homing signal comprises a message about firmware update, cable card firmware update data, and a time that is required to update the firmware. The interface 110 can be embodied by an input port connected to a cable. Accordingly, the interface 110 facilitates homing signal input through the input port to the update part 120.

The update part 120 updates the firmware of the cable card 130 using the homing signal. More specifically, the update part 120 can, for example, update the subscriber information stored in the firmware of the cable card 130 or upgrade the version of the firmware. The update part 120 notifies the message generator 140 of the firmware update.

The message generator 140 generates a message indicating the update of the firmware. More specifically, the message generator 140 can generate a message indicating, for example, version upgrade, extension of cable card usage period, and change in broadcast program.

The storage part 160 stores corresponding node information about a pre-set corresponding node. The corresponding node information designates a node to transmit the message about the update. For example, a telephone number or an e-mail address may be used as the corresponding node information.

The corresponding node information is arbitrarily established and stored by a user.

The OSD processor 170 generates an OSD through which a user inputs the corresponding node information, and displays the OSD on a screen. The corresponding node information input by the user through the OSD is stored in the storage part 160.

The communication part 150 transmits the message generated by the message generator 140 to a node corresponding to the node information stored in the storage part 160.

If the corresponding node information is a phone number, the communication part 150 transmits the message in the form of a short service server (SMS) text message through a SMS center.

FIG. 2 is a view illustrating an exemplary environment where the display device 100 operates when the corresponding node information comprises a phone number. Referring to FIG. 2, if the display device 100 receives homing information from a service provider 10 and updates the firmware of the cable card 130, the display device 100 is able to access a SMS center (SMSC) 30 through a network, such as, for example, the Internet. The display device 100 then provides the SMSC 30 with the generated message and phone number.

A mobile terminal, such as a mobile telephone, communicates with the SMSC 30 through a mobile network. However, the display device 100 communicates with the SMSC 30 through a public switched telephone network (PSTN) as well as through the mobile network. In order to provide an SMS function through a network, the display device 100 provides the message and phone number according to a communication protocol, such as, for example, ES 201 912 approved by the European telecommunication standard institute.

With reference to the received phone number, the SMSC 30 transmits the message to a mobile switching center (MSC) that controls communications of the area where a corresponding node 40 is located. Accordingly, the display device 100 notifies node 40 corresponding to the telephone number of the firmware update in the form of an SMS text message.

The SMSC 30 transmits the SMS text message repeatedly and periodically until it receives an SMS receipt confirmation message from the corresponding node 40. If there is no SMS receipt confirmation message received for a period of time, the SMS center 30 transmits an error message about the failure to transmit the message to the display device 100.

In another exemplary embodiment, the corresponding node information may be an e-mail address. When the corresponding node information comprises an e-mail address, the communication part 150 accesses a web-mail server through the Internet and provides an e-mail address and the generated message. Accordingly, the message about the update is transmitted to a corresponding node via e-mail.

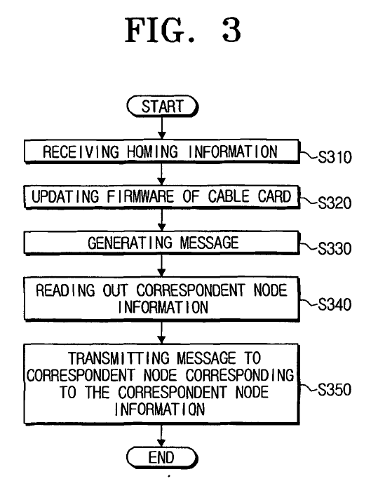

FIG. 3 is a flowchart illustrating a method for updating firmware of a cable card according to an exemplary embodiment of the present invention. Referring to FIG. 3, if homing information is received, step S310, cable card firmware is updated according to the homing information received, step S320.

A message about the firmware update is generated at step S330. The message may comprise changes to subscriber information or version upgrade.

Corresponding node information is read from memory at step S340. The corresponding node information can be, for example, a phone number or e-mail address.

The message is then transmitted to a node corresponding to the node information read, step S350. The message can be transmitted to the corresponding node through an SMSC or web-mail server.

As described above, when the firmware of the cable card 130 is updated, the update is transmitted to a pre-set terminal device. Accordingly, users can be made aware of the occurrence of a firmware update.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. A display device comprising:
a cable card that stores firmware;
an interface that receives homing information from a service provider,
an update part that updates the cable card firmware according to the homing information;
a storage part that stores correspondent node information about at least one corresponding node; and
a message generator that generates a message indicating an update of the cable card firmware; and
a communication part that transmits the message to the at least one correspondent node.

2. The display device as claimed in claim 1, wherein the correspondent node information comprises a telephone number.

3. The display device as claimed in claim 2, wherein the communication part accesses a short message service center (SMSC) and provides the SMSC with the telephone number and the message, and the SMSC transmits the message to a node corresponding to the telephone number.

4. The display device as claimed in claim 3, further comprising an on screen display (OSD) processor that receives the telephone number and stores the telephone number to the storage part.

5. The display device as claimed in claim 3, wherein the SMSC transmits the message to a node corresponding to the telephone number in the form of an SMS text message.

6. A method for updating a display device cable card, the method comprising:
receiving homing information from a service provider,
updating cable card firmware according to the homing information;
generating a message indicative of the updating of the firmware; and
transmitting the message to a corresponding node.

7. The method as claimed in claim 6, wherein the transmission of the message comprises:
reading a telephone number from memory,
accessing a short message service center (SMSC); and
providing the SMSC with the telephone number and the message;
wherein the SMSC transmits an SMS text message to a node corresponding to the telephone number.

8. A computer readable medium having stored thereon instructions for updating a display device cable card, comprising:
a first set of instructions for receiving honing information from a service provider,
a second set of instructions for updating cable card firmware according to the homing information;
a third set of instructions for generating a message indicating firmware update; and
a fourth set of instructions for transmitting the message to a corresponding node.

9. The computer readable medium of claim 8, wherein the message transmission comprises:
a fifth set of instructions for reading a telephone number from memory,
a sixth set of instructions for accessing a short message service center (SMSC); and
a seventh set of instructions for providing the SMSC with the telephone number and the message;
wherein the SMSC transmits an SMS text message to a node corresponding to the telephone number.
